(19) United States
(12) Patent Application Publication
(10) Pub. No.: US 2013/0286113 A1
(43) Pub. Date: Oct. 31, 2013

(54) INK TANK SEAL RETAINER WITH SYMMETRIC SEAL FORCE

(71) Applicants: Joseph W. Hoff, Fairport, NY (US); Douglas Harold Pearson, Rochester, NY (US); Steven Lee Moore, Dansville, NY (US); Michael Louis DeCecca, Fairport, NY (US); Kevin J. O'Leary, Rochester, NY (US)

(72) Inventors: Joseph W. Hoff, Fairport, NY (US); Douglas Harold Pearson, Rochester, NY (US); Steven Lee Moore, Dansville, NY (US); Michael Louis DeCecca, Fairport, NY (US); Kevin J. O'Leary, Rochester, NY (US)

(21) Appl. No.: 13/459,567

(22) Filed: Apr. 30, 2012

(51) Int. Cl. B41J 2/175; F16J 15/10; F16J 15/06

(52) U.S. Cl. 347/86; 277/637

(57) ABSTRACT

A seal includes a seal member; and a seal retainer having a housing for the seal member, the housing including a first thickness near a first end and a second thickness near a second end, wherein the first thickness does not equal the second thickness; a wall extending from the first end of the housing, the wall including a latch opening; a first hook on a first side of the seal retainer; and a second hook on a second side of the seal retainer, the second side being opposite the first side, wherein the first hook and second hook are disposed proximate the second end of the housing, and wherein a force applied to the seal member by the housing near the first end is equal to a force applied to the seal member by the housing near the second end when the seal is assembled onto the ink tank.

### CROSS REFERENCE TO RELATED APPLICATIONS

Reference is made to commonly assigned U.S. patent application Ser. No. ______ (K000935) ______ filed ______ by Joseph W. Hoff, Douglas H. Pearson, Steven L. Moore, Michael L. Dececca and Kevin J. O'leary, entitled “Seal Retainer with Retainer Spreaders on Handle”, commonly assigned U.S. patent application Ser. No. ______ (K001038) ______ filed ______ by Kevin O'Leary and Steven L. Moore, entitled “Snap-on Seal for Inkjet Ink Tank”, and commonly assigned U.S. patent application Ser. No. ______ (K0001039) ______ filed ______ by Kevin J. O′Leary and Steven L. Moore, entitled “Inkjet Ink Tank for Snap-On Seal”, the disclosures of which are herein incorporated by reference.

### FIELD OF THE INVENTION

The present invention relates generally to an ink tank for an inkjet printer, and more particularly to a seal including a seal retainer for sealing an outlet port of the ink tank during, for example, shipping and storage.

### BACKGROUND OF THE INVENTION

An inkjet printing system typically includes one or more printheads and their corresponding ink supplies. Each printhead includes an ink inlet that is connected to its ink supply and an array of drop ejectors, each ejector includes an ink pressurization chamber, an ejecting actuator and a nozzle through which droplets of ink are ejected. The ejecting actuator may be one of various types, including a heater that vaporizes some of the ink in the pressurization chamber in order to propel a droplet out of the orifice, or a piezoelectric device which changes the wall geometry of the chamber in order to produce a pressure wave that ejects a droplet. The droplets are typically directed toward paper or other recording medium in order to produce an image according to image data that is converted into electronic firing pulses for the drop ejectors as the recording medium is moved relative to the printhead.

A common type of printer architecture is the carriage printer, where the printhead nozzle array is somewhat smaller than the extent of the region of interest for printing on the recording medium and the printhead is mounted on a carriage. In a carriage printer, the recording medium is advanced a given distance along a media advance direction and then stopped. While the recording medium is stopped, the printhead carriage is moved in a direction that is substantially perpendicular to the media advance direction as the drops are ejected from the nozzles. After the carriage has printed a swath of the image while traversing the recording medium, the recording medium is advanced; the carriage direction of motion is reversed; and the image is formed swath by swath.

The ink supply on a carriage printer can be mounted on the carriage or off the carriage. For the case of ink supplies mounted on the carriage, the ink tank can be permanently integrated with the printhead as a print cartridge so that the printhead needs to be replaced when the ink is depleted, or the ink tank can be detachably mounted to the printhead so that only the ink tank itself needs to be replaced when the ink tank is depleted. Detachably mounted ink tanks for a carriage printer typically contain only enough ink for up to about several hundred prints. This is because the total mass of the carriage needs be limited so that accelerations of the carriage at each end of the travel do not result in large forces that can shake the printer back and forth. As a result, users of carriage printers need to replace carriage-mounted ink tanks periodically depending on their printing usage, typically several times per year. Consequently, the task of replacing a detachably mounted ink tank in the holding receptacle should be simple and reliable. Ink tanks can contain a single color ink, or they can have several ink chambers each containing a different color ink that is supplied to the printhead through a corresponding outlet port.

Inkjet ink includes a variety of volatile and nonvolatile components including pigments or dyes, humectants, image durability enhancers, and carriers or solvents. For proper operation of the inkjet printhead it is important that the ink transferred from the outlet port of the ink tank to the inlet port of the printhead has the appropriate balance of these ink components. Therefore, during shipping and storage of an inkjet ink tank, it is common practice to provide a seal over the outlet port or outlet ports of the ink tank in order to inhibit the evaporative loss of the volatile components of the ink. U.S. Pat. No. 6,464,339 discloses a removable seal that is adhesively attached over the outlet port of an ink tank. U.S. Pat. No. 7,967,426 (incorporated herein by reference) discloses a sealing device including a compliant sealing member and a retainer having a latching feature to facilitate latching of the sealing device to an ink tank and also a protective region for protecting a circuit device on the ink tank. U.S. Patent Application Publication No. 2011/0292137 (incorporated herein by reference) discloses a sealing device including a seal retainer with a seal housing having attachment members that are attached to the ink tank by welding, for example, and a hinged handle for removing the seal retainer.

The various removable seals currently used and disclosed in the prior art work in a satisfactory fashion, but what is needed in some applications is a seal and seal retainer that has improved seal reliability even after significant storage time at elevated temperature, as might be experienced in a warehouse for example. This is particularly true for seal retainers made of less costly unfilled plastics. In addition it would be further advantageous if the seal retainer enabled a greater latitude in the design of the elastomeric seal member that is held in contact with the outlet port of the ink tank by the seal retainer.

### SUMMARY OF THE INVENTION

The present invention is directed to overcoming one or more of the problems set forth above. Briefly summarized, according to one aspect of the invention, the invention resides in a seal for an outlet port of an ink tank, the seal includes a seal member; and a seal retainer having a housing for the seal member, the housing including a first thickness near a first end and a second thickness near a second end, wherein the first thickness does not equal the second thickness; a wall extending from the first end of the housing, the wall including a latch opening; a first hook on a first side of the seal retainer; and a second hook on a second side of the seal retainer, the second side being opposite the first side, wherein the first hook and second hook are disposed proximate the second end of the housing, and wherein a force applied to the seal member by the housing near the first end is equal to or substantially equal to a force applied to the seal member by the housing near the second end when the seal is assembled onto the ink tank.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic representation of an inkjet printer system;

FIG. 2 is a perspective of a portion of a printhead;

FIG. 3 is a perspective of a portion of a carriage printer;

FIG. 4 is a schematic side view of an exemplary paper path in a carriage printer;

FIG. 5 is a perspective of a portion of a printhead;

FIG. 6 is a perspective of an ink tank with outlet port facing up, according to an embodiment of the invention;

FIG. 7 is a perspective of the ink tank of FIG. 6 with a seal installed over the outlet port, according to an embodiment of the invention;

FIG. 8 is a perspective of the seal of FIG. 7 without the ink tank;

FIG. 9 is an upside down perspective of the seal of FIG. 8;

FIG. 10 is a cross section through A-A′ of FIG. 9;

FIG. 11 is a perspective of a shaped seal member;

FIG. 12 is a perspective of a flat gasket seal member;

FIG. 13 is a perspective of an installed state of a seal including a handle with wedge-shaped feet for spreading apart hooked legs on the seal to aid in its removal according to an embodiment of the invention;

FIG. 14 is a perspective of the seal and handle in a removed state from the ink tank;

FIG. 15 is a perspective that is rotated relative to FIG. 14;

FIG. 16 is a top view of an installed state of the seal with handle on the ink tank;

FIG. 17 is a perspective of the installed state of the seal with handle;

FIG. 18 is a perspective of an intermediate state of the seal with handle as it is removed from the ink tank; and

FIG. 19 is a perspective of a removed state of the seal with handle from the ink tank.

### DETAILED DESCRIPTION OF THE INVENTION

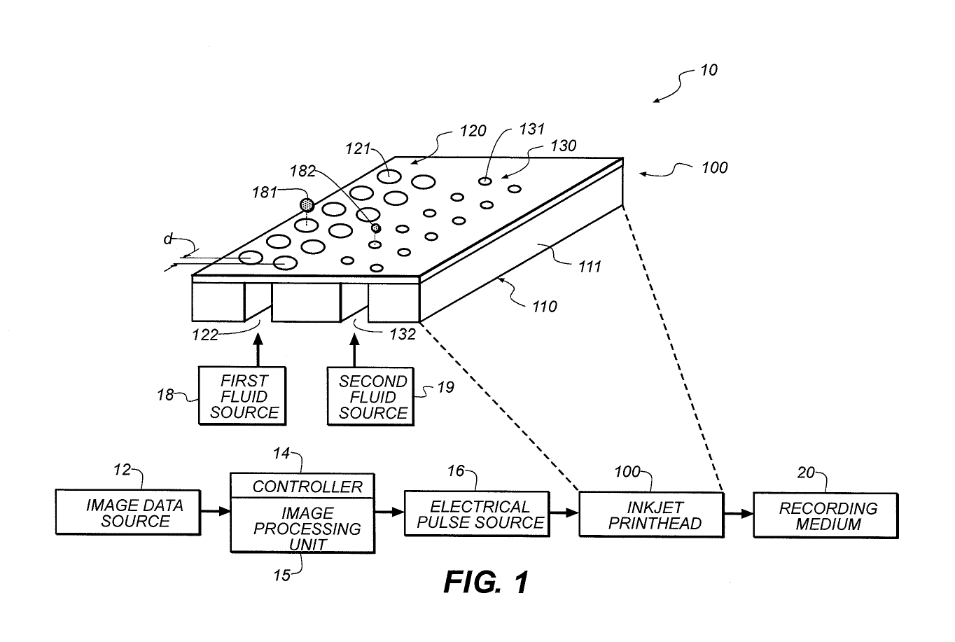

Referring to FIG. 1, a schematic representation of an inkjet printer system 10 is shown, for its usefulness with the present invention and is fully described in U.S. Pat. No. 7,350,902, and is incorporated by reference herein in its entirety. Inkjet printer system 10 includes an image data source 12, which provides data signals that are interpreted by a controller 14 as commands to eject drops. The controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays 120 and 130. Nozzles 121 in the first nozzle array 120 have a larger opening area than nozzles 131 in the second nozzle array 130. In this example, each of the two nozzle arrays 120, 130 has two staggered rows of nozzles 121, 131, each row having a nozzle density of 600 per inch. The effective nozzle density then in each array is 1200 per inch (i.e. d= 1/1200 inch in FIG. 1). If pixels on the recording medium 20 were sequentially numbered along the paper advance direction, the nozzles from one row of an array would print the odd numbered pixels, while the nozzles from the other row of the array would print the even numbered pixels.

In fluid communication with each nozzle array 120 and 130 is a corresponding ink delivery pathway 122 and 132. The ink delivery pathway 122 is in fluid communication with the first nozzle array 120, and ink delivery pathway 132 is in fluid communication with the second nozzle array 130. Portions of the ink delivery pathways 122 and 132 are shown in FIG. 1 as openings through a printhead die substrate 111. One or more inkjet printhead die 110 will be included in the inkjet printhead 100, but for greater clarity only one inkjet printhead die 110 is shown in FIG. 1. In FIG. 1, a first fluid source 18 supplies ink to the first nozzle array 120 via the ink delivery pathway 122, and a second fluid source 19 supplies ink to the second nozzle array 130 via the ink delivery pathway 132. Although distinct fluid sources 18 and 19 are shown, in some applications it may be beneficial to have a single fluid source, such as black ink, supplying ink to both the first nozzle array 120 and the second nozzle array 130 via the ink delivery pathways 122 and 132 respectively. Also, in some embodiments, fewer than two or more than two nozzle arrays 120 and 130 can be included on the printhead die 110. In some embodiments, all nozzles on the inkjet printhead die 110 can be the same size, rather than having multiple sized nozzles 121 and 131 on the inkjet printhead die 110.

The drop forming mechanisms associated with the nozzles 121, 131 are not shown in FIG. 1. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from the electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with the nozzle arrays 120 and 130 are also sized differently in order to optimize the drop ejection process for the different sized drops. During operation, droplets of ink are deposited on a recording medium 20.

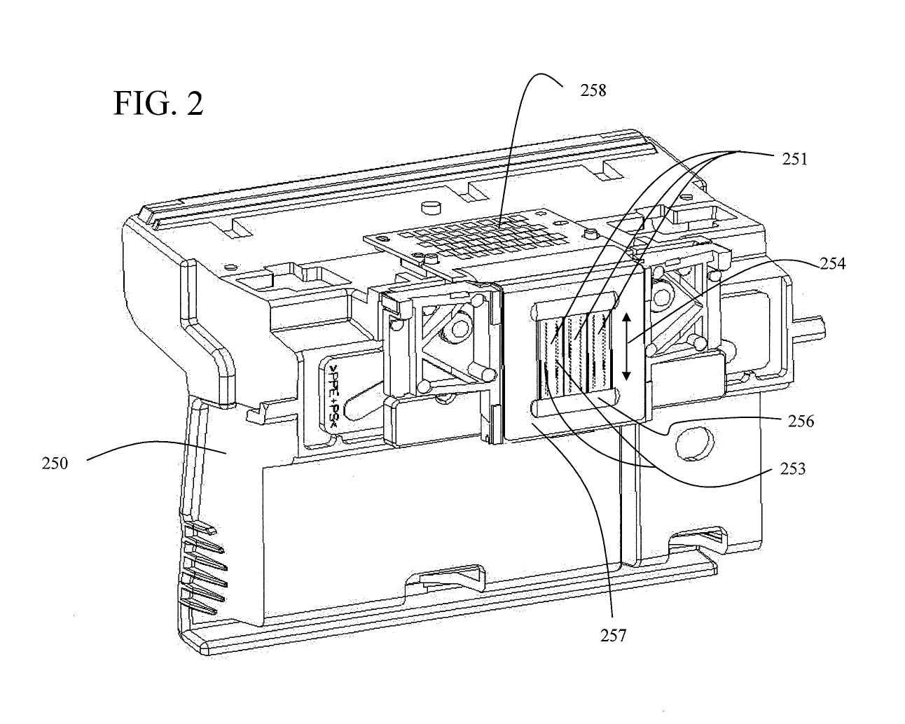

FIG. 2 shows a perspective of a portion of a printhead 250, which is an example of the inkjet printhead 100. The printhead 250 includes three printhead die 251 (similar to the printhead die 110 in FIG. 1), each printhead die 251 containing two nozzle arrays 253 so that the printhead 250 contains six nozzle arrays 253 altogether. The six nozzle arrays 253 in this example can be connected to ink sources (not shown in FIG. 2); such as cyan, magenta, yellow, text black, and photo black. Two of the nozzle arrays 253 can be connected to a single ink source such as text black. Each of the six nozzle arrays 253 is disposed along a nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving the printhead 250 across the recording medium 20. Following the printing of a swath, the recording medium 20 is advanced along a media advance direction that is substantially parallel to the nozzle array direction 254.

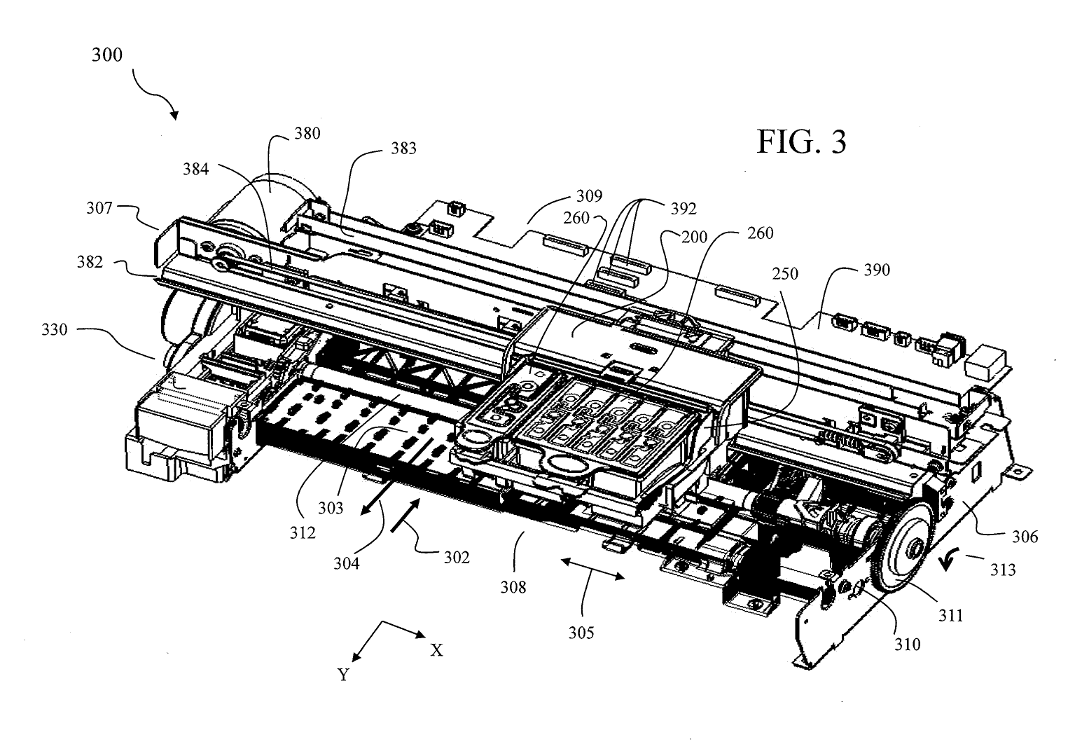

A flex circuit 257 is electrically connected to the printhead die 251, for example, by wire bonding or TAB bonding. The interconnections are covered by an encapsulant 256 to protect them. The flex circuit 257 bends around the side of the printhead 250 and connects to the connector board 258. When the printhead 250 is mounted into a carriage 200 (see FIG. 3), the connector board 258 is electrically connected to a connector (not shown) on the carriage 200 so that electrical signals can be transmitted to the printhead die 251.

FIG. 3 shows a portion of a desktop carriage printer. Some of the parts of the printer have been hidden in the view shown in FIG. 3 so that other parts can be more clearly seen. A printer chassis 300 has a print region 303 across which the carriage 200 is moved back and forth in a carriage scan direction 305 along the X axis, between a right side 306 and a left side 307 of the printer chassis 300, while drops are ejected from the printhead die 251 (not shown in FIG. 3) on the printhead 250 that is mounted on the carriage 200. A carriage motor 380 moves a belt 384 to move the carriage 200 along a carriage guide rail 382. An encoder sensor (not shown) is mounted on the carriage 200 and indicates carriage location relative to an encoder fence 383.

The printhead 250 is mounted in the carriage 200, and ink tanks 260 are installed in the printhead 250. The mounting orientation of the printhead 250 is rotated relative to the view in FIG. 2 so that the printhead die 251 are located at the bottom side of the printhead 250; the droplets of ink ejected downward onto the recording medium 20 in the print region 303 in the view of FIG. 3.

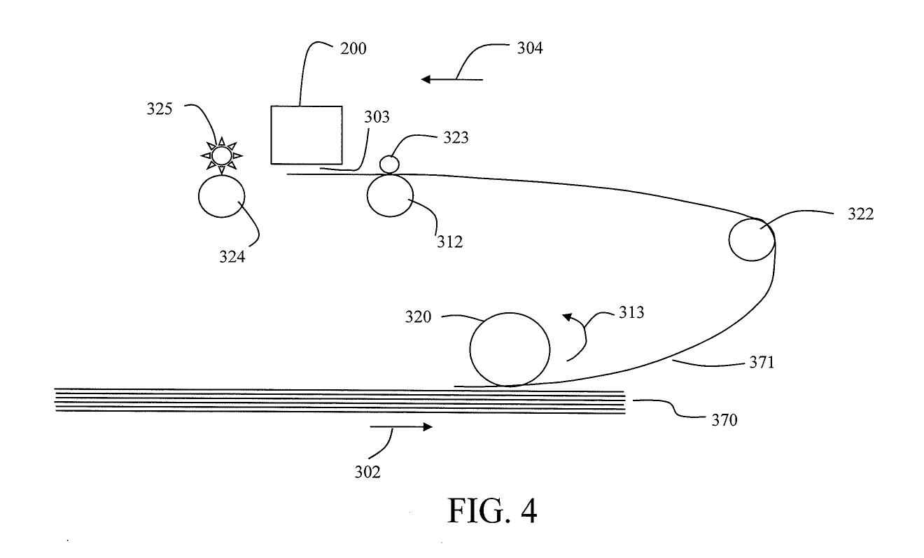

Paper or other recording medium 20 (sometimes generically referred to as paper or media herein) is loaded along a paper load entry direction 302 toward a front of printer chassis 308. A variety of rollers are used to advance the recording medium 20 through the printer as shown schematically in the side view of FIG. 4. In this example, a pick-up roller 320 moves a top piece or sheet 371 of a stack 370 of paper or other recording medium 20 in the direction of arrow, the paper load entry direction 302. A turn roller 322 acts to move the paper around a C-shaped path (in cooperation with a curved rear wall surface) so that the paper continues to advance along a media advance direction 304 from the rear of the printer chassis 309 (with reference also to FIG. 3). The paper is then moved by feed roller 312 and idler roller(s) 323 to advance along the Y axis across the print region 303, and from there to a discharge roller 324 and star wheel(s) 325 so that printed paper exits along media advance direction 304. The feed roller 312 includes a feed roller shaft along its axis, and a feed roller gear 311 is mounted on the feed roller shaft. The feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but a hole 310 at the right side of the printer chassis 306 is where the motor gear (not shown) protrudes through in order to engage the feed roller gear 311, as well as the gear for the discharge roller (not shown). For normal paper pick-up and feeding, it is desired that all rollers rotate in a forward rotation direction 313. Toward the left side of the printer chassis 307, in the example of FIG. 3, is a maintenance station 330.

Toward the rear of the printer chassis 309, in this example, is located an electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a processor and other control electronics (shown schematically as the controller 14 and the image processing unit 15 in FIG. 1) for controlling the printing process, and an optional connector for a cable to a host computer.

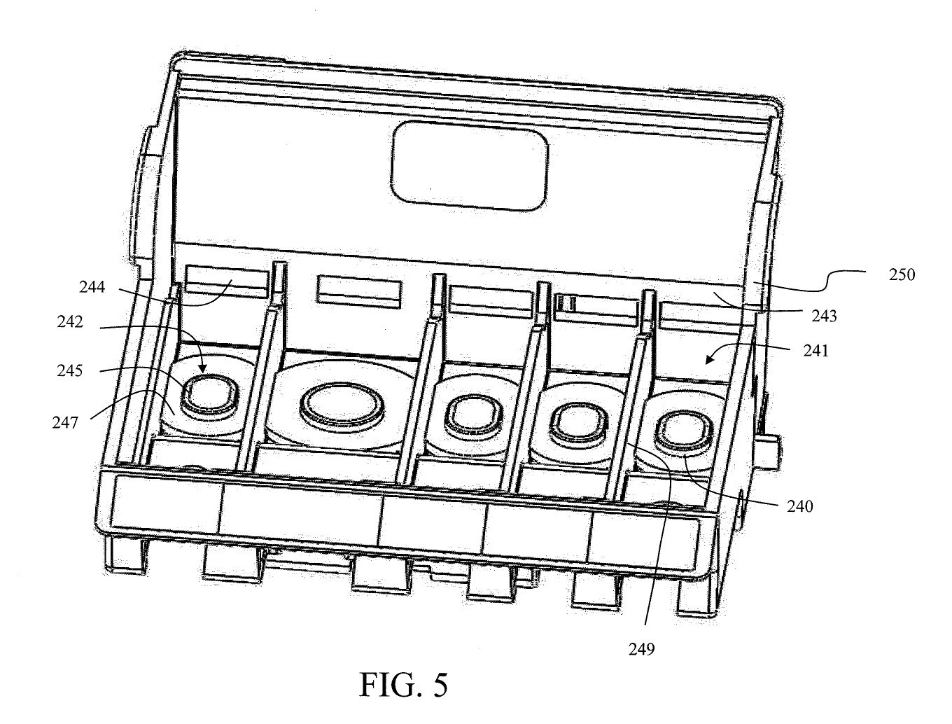

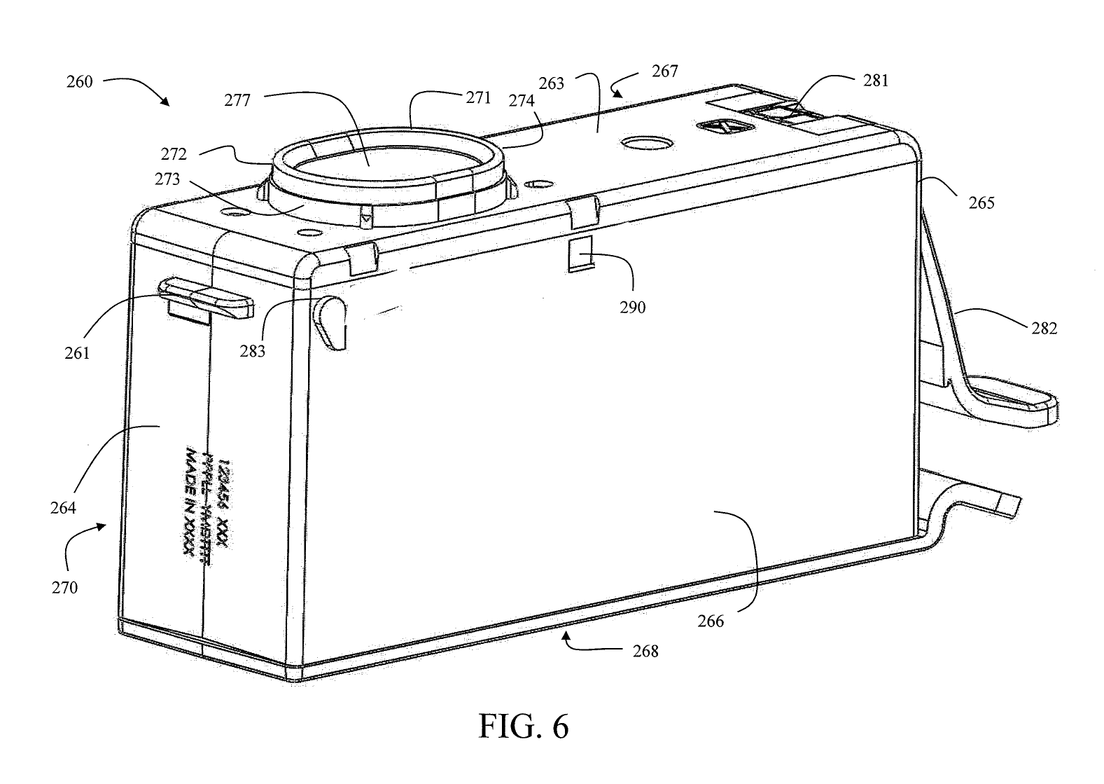

FIG. 5 shows a perspective of the printhead 250 (rotated with respect to FIG. 2) without the replaceable ink tanks 260 mounted onto it. In this example, the individual ink tanks 260 (FIG. 6) are detachably mountable in ink tank holding receptacles 241. The holding receptacles 241 are separated from each other by partitioning walls 249. Five inlet ports 242 are shown in corresponding holding receptacles 241. Each inlet port 242 is fluidically connected with a corresponding outlet port 272 (FIG. 6) of the ink tank 260 when it is installed onto the printhead 250. In the example of FIG. 5 each inlet port 242 has the form of a standpipe 240 that extends from the floor of the printhead 250. Typically a filter (such as woven or mesh wire filter, not shown) covers the end 245 of the standpipe 240. The size of the end 245 of the standpipe 240 is typically smaller than that of the opening of outlet port 272 (see FIG. 6) of the ink tank 260 so that the end 245 of each standpipe 240 is pressed into contact with a corresponding wick 277 at the opening of outlet port 272. In other words, the wick 277 serves as a printhead interface member for the ink tank 260. On the floor of printhead 250 surrounding the standpipes 240 of the inlet ports 242 is an elastomeric gasket 247 for sealing against an end face 271 of the outlet port 272 of the ink tank 260 to keep air from leaking into the ink passageways. When an ink tank 260 is installed into the corresponding ink tank holding receptacle 241 of the printhead 250, it is in fluid communication with the printhead 250 because of the connection of the wick 277 at the outlet port 272 with the end 245 of the standpipe 240 of the inlet port 242. Also shown in FIG. 5 is an opening 244 in the inner wall 243 of each holding receptacle 241 that is provided for engaging with a protrusion 261 (FIG. 6).

An exemplary ink tank 260 is shown in FIG. 6. The ink tank 260 includes a body 270 with a lid 268 affixed to it. The ink tank body 270 includes an outlet wall 263; a lead end wall 264 that is configured to be near the printhead 250 when installation of the ink tank 260 into the printhead 250 (FIG. 5) begins; a trail end wall 265 that is opposite the lead end wall 264 so that it is distal to the printhead 250 when installation of the ink tank 260 begins; a first side wall 266 extending from the lead end wall 264 to the trail end wall 265 and intersecting the outlet wall 263, and a second side wall 267 opposite the first side wall 266. The outlet wall 263 includes the outlet port 272 for providing ink to the inlet port 242 of the printhead 250. The outlet port 272 has a first end 273 that is closer to the lead end wall 264 and a second end 274 that is farther from the lead end wall 264. In some embodiments, as shown in FIG. 6, an electrical device 281 is provided on the outlet wall 263 for tracking ink usage for example. The lead end wall 264 includes a protrusion 261 for engaging with the opening 244 (FIG. 5) in an inner wall 243 of the printhead 250 when the ink tank 260 is installed. A latch lever 282 is provided on the trail end wall 265 to latch the installed ink tank 260 to the printhead 250. The first and second side walls 266 and 267 each include guide features 283 that ride on the partition walls 249 (FIG. 5) as the ink tank 260 is installed in the printhead 250. According to embodiments of the present invention, the first and second side walls 266 and 267 each include indentations 290 near the outlet wall 263 for attaching a seal retainer as described below. The indentation 290 is visible on the first side wall 266 but is not visible on the second side wall 267 in the perspective of FIG. 6.

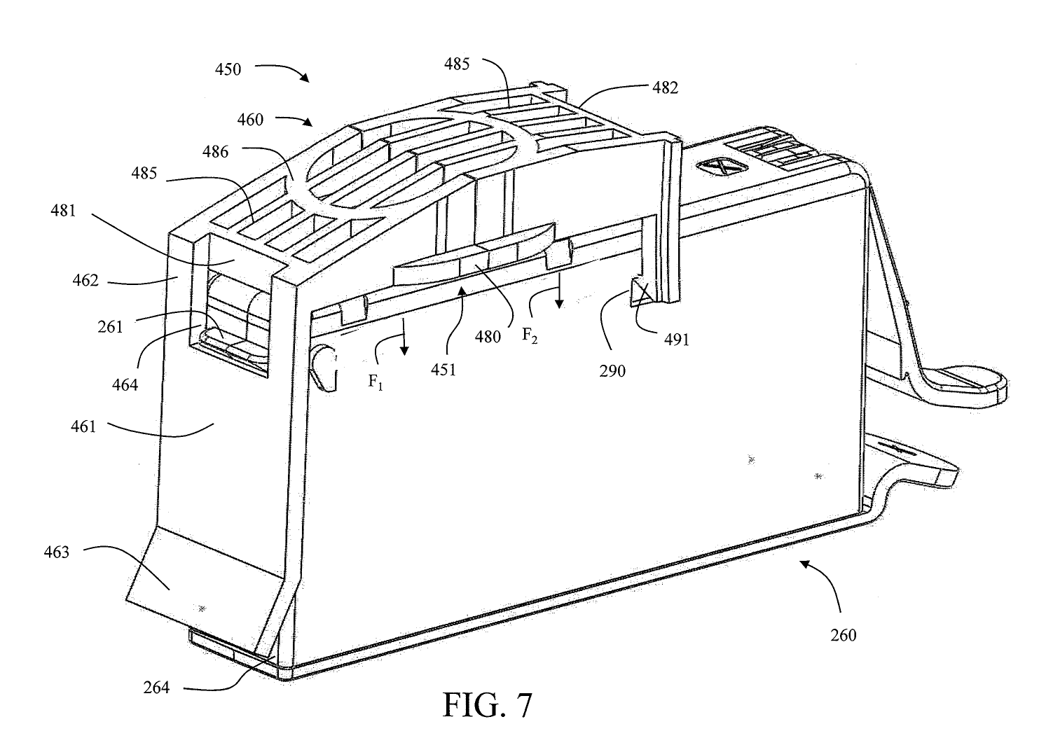

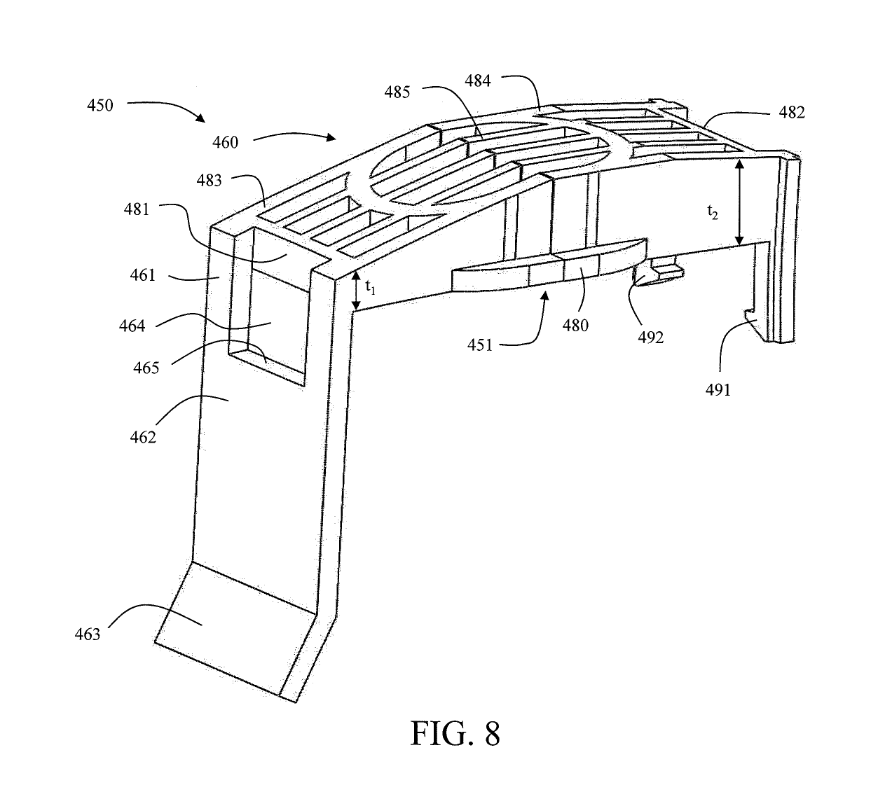

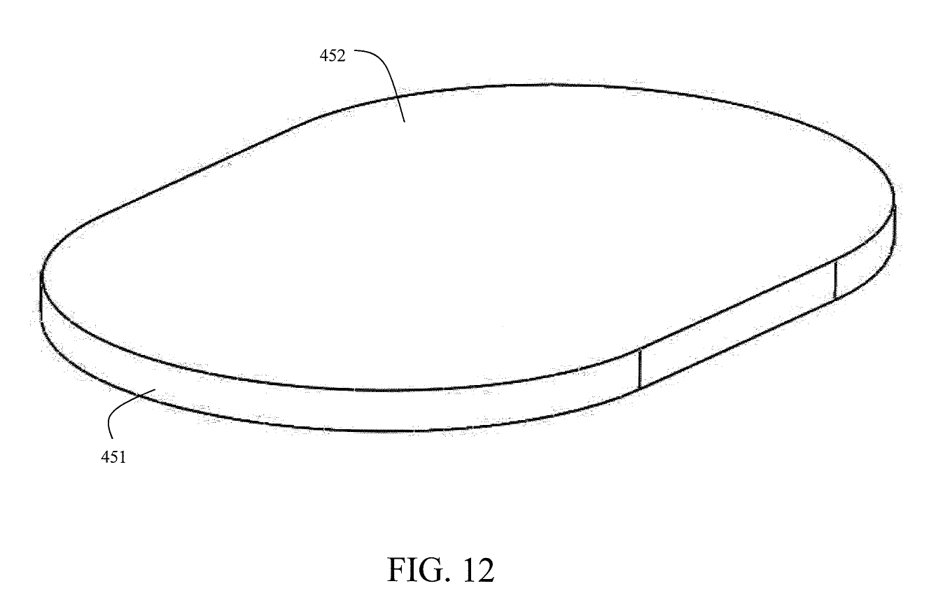

FIG. 7 is a perspective of the ink tank 260 of FIG. 6 with a removable seal 450 installed over the outlet port 272 according to an embodiment of the present invention. FIG. 8 is a similar perspective as FIG. 7, but without the ink tank 260, in order to show details of the seal 450 more clearly. The seal 450 is sometimes called a shipping seal and is used during shipping and storage of the ink tank 260. The seal 450 needs to provide a reliable seal over the outlet port 272 to inhibit evaporation of volatile components from the ink despite changes in temperature and atmospheric pressure. It also needs to be easily assembled onto the ink tank 260 and easily removed by the customer before installing the ink tank 260 into the printhead 250. The seal 450 includes a seal retainer 460 having a housing 480 that holds a seal member 451 (FIG. 12) in contact with the end face 271 (FIG. 6) of the outlet port 272, as is described in more detail below. The seal retainer 460 applies a force to the seal member 451 by being latched into a deformed state. The force is applied by the tendency of the seal retainer 460 to elastically resume its undeformed state, similar to a coil spring that has been extended and is in tension. In order to keep costs low for the seal 450, the seal retainer 460 is typically injection molded from plastics without filler materials, for example polypropylene without glass or carbon fillers. Although such unfilled plastic materials have acceptable strength to cost ratio (having a Young's modulus that is typically in the range between 100,000 and 500,000 pounds per square inch), they typically have a tendency to lose some of their elastic performance when exposed to a fixed displacement and long-term exposure to temperatures on the order of 60 degrees C., as might be experienced in a warehouse without climate control.

Some configurations of seal retainers have attachment geometries that are asymmetric from one end of the outlet port 272 to the other, i.e. asymmetric about a mid-plane between the first end 273 and the second end 274 of the outlet port 272. For example, in the example shown in FIGS. 7-9, the seal retainer 460 includes a wall 461 extending from a first end 481 of housing 480. A first portion 462 of wall 461 includes a latch opening 464 having an edge 465 (FIG. 8) that engages with protrusion 261 on the lead wall 264 of ink tank 260, thereby providing a compressive force F₁ on the seal member 451 near a first end 481 of the housing 480. The seal retainer 460 also includes a first hook 491 on a first side and a second hook 492 (FIG. 8) on a second side opposite the first side.

The first hook 491 and the second hook 492 are located near second end 482 of the housing 480. First hook 491 (FIG. 7) and second hook 492 (not shown in FIG. 7) are disposed in the indentations 290 on the first side wall 266 and the second side wall 267 respectively, thereby providing a compressive force F₂ on the seal member 451 near a second end 482 of the housing 480.

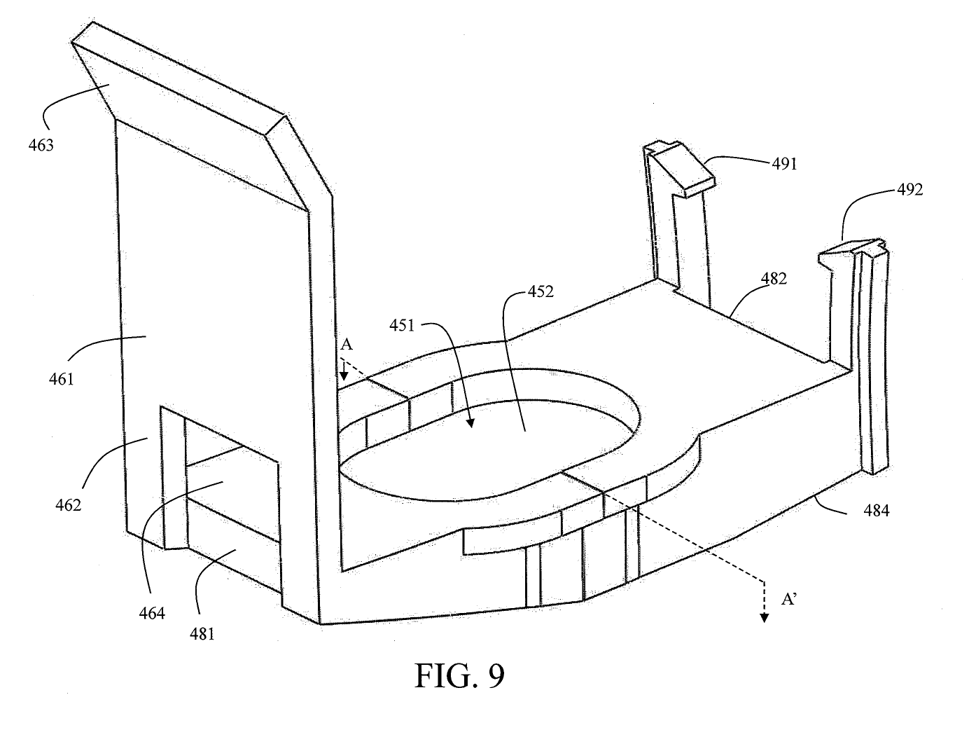

For reliable sealing of the seal 450 against the outlet port 272 that can withstand changes in temperature and atmospheric pressure, as well as relaxation of the plastic material forming the seal retainer 460 during exposure to elevated temperature while installed on the ink tank 260 in a distorted condition, it is important to design the seal retainer 460 such that F₁ is equal to or substantially equal to F₂, even though the attaching geometries are not symmetric about the midplane defined by A-A′ in FIG. 9. It has been found that by making a first thickness t₁ of the housing 480 near the first end 481 to be unequal to a second thickness t₂ of the housing 480 near the second end 482, the effective spring constants of the seal retainer 460 in those two regions can be provided such that F₁ is equal to or substantially equal to F₂. In the example shown in FIGS. 8-9 (where FIG. 9 is a perspective of the seal 450 as seen from the underside), the seal member 451 has a sealing face 452. A first outer side 483 near first end 481 of housing 480 is sloped relative to sealing face 452, while a second outer side 484 near the second end 482 of the housing 480 is parallel to or substantially parallel to the sealing face 452. The slope of the first outer side 483 is such that a thickness t₁ of the first outer side 483 of the housing 480 near the first end 481 is less than a thickness t₂ of the second outer side 484 of the housing 480 near the second end 482.

As seen in FIG. 9, a first portion 462 of the wall 461 near the seal member 451 extends perpendicular to or substantially perpendicular to the sealing face 452 of the seal member 451. The latch opening 464 is located in the first portion 462 of the wall 461. A second portion 463 of the wall 461 located farther from the seal member 451 near the end of the wall 461 extends obliquely relative to the sealing face 452 of the seal member 451. By bending outward away from the lead end wall 264 of the ink tank 260 (see FIG. 6), the second portion 463 is more easy for the user to grasp as a handle when removing the seal retainer 460 from the ink tank 260.

As seen in FIGS. 7 and 8, the housing 480 includes a plurality of the ribs 485 that extend along a direction from the first end 481 to the second end 482. The effective spring constants of the housing 480 on either side of the midplane defined by A-A′ in FIG. 9 are influenced by the number and geometries of the ribs 485. In addition, provision of the ribs 485 separated by grooves permits feature thickness to be substantially uniform in the seal retainer 460, thereby facilitating injection molding with less distortion in the parts. The housing 480 also include a plurality of braces 486 that join adjacent the ribs 485, providing greater strength and resistance to twisting and buckling. In the example shown in FIGS. 6, 7 and 8, the braces 486 form a curved contour that has the same contour as the outlet port 272.

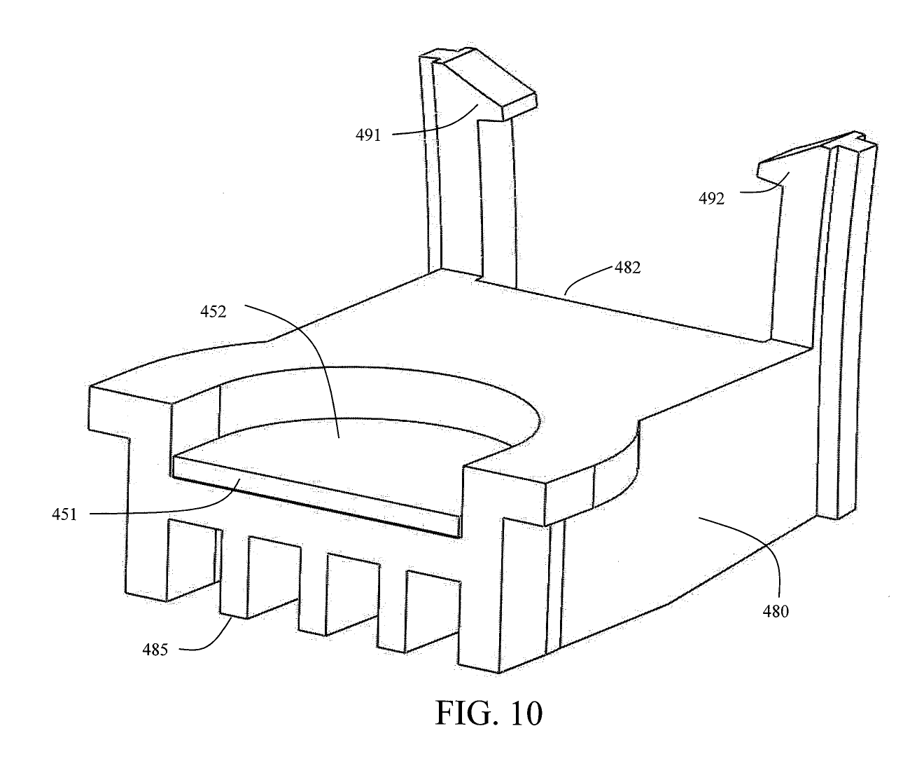

FIG. 10 is a cross-section of the housing 480 along the midplane defined by A-A′ in FIG. 9. FIG. 10 shows the location of the seal member 451 within the housing 480. The seal member 451 can be affixed to the housing 480 of the seal retainer 460 by press fitting, by adhesive, or by two-shot molding, for example.

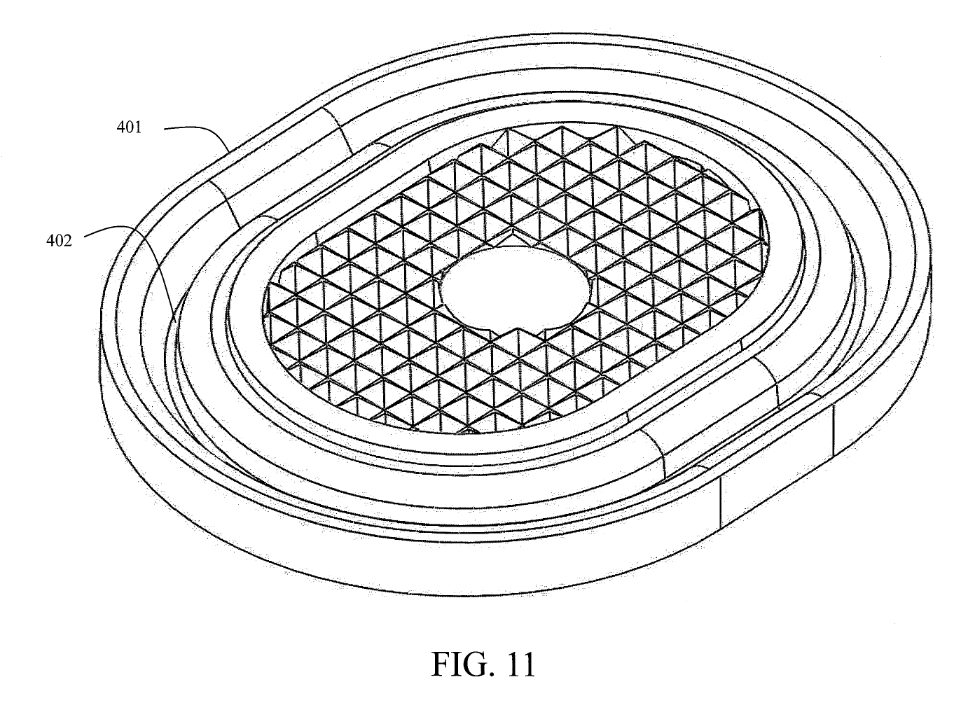

The seal member 451 is typically made of an elastomeric material so that it is readily compressible. In some embodiments, the seal member 451 can be a shaped seal member 401, such as the one shown in FIG. 11, having a sealing face 402 in a groove to conform to the end face 271 (FIG. 6) of the outlet port 272. An advantage of the present invention is that by providing equal forces F₁ and F₂ as described above, greater latitude of seal member design is provided. In some embodiments, as shown in FIGS. 9, 10 and 12 a flat seal member 451 (i.e. a flat gasket) having a flat sealing face 452 can be used. This eliminates the need for high precision alignment of the seal member 451 to the outlet port 272 of the ink tank 260.

A seal retainer 460 made of an unfilled plastic can have an initial elasticity as made and a relaxed elasticity after the seal retainer 460 has been exposed to elevated temperature while installed in its deformed state on the ink tank 260. For example, in a warehouse that is not climate controlled in some countries, the ink tanks 260 with the shipping seals 450 installed can be stored at a temperature of approximately 60 degrees Centigrade for more than 100 hours, or even more than 300 hours. The relaxed elasticity of an unfilled plastic such as polypropylene can be reduced to approximately 25% of the initial elasticity as the material stress relaxes under load. Thus, the housing 480 should be designed with the relaxed elasticity in mind so that the seal forces remain sufficiently strong. If an ink tank 260 has been filled with ink at an atmospheric pressure of 1 atmosphere (approximately 15 pounds per square inch), then the seal 450 is installed, followed by storage at approximately 60 degrees Centigrade for more than 100 hours, and then is shipped by air to another location at an ambient pressure near 0 psi, the seal 450 should not leak. In other words, the seal retainer 460 needs to have sufficient elasticity and strength to withstand an internal pressurization of at least 15 pounds per square inch relative to external pressure after the seal retainer is exposed to 60 degrees Centigrade of more than 100 hours, or even more than 300 hours while installed in the ink tank 260.

Advantages of the present embodiments described above include: 1) A uniform sealing force is applied by providing matched spring rates for the primary structural elements in the seal retainer 460. 2) The use of inexpensive unfilled plastic in the seal retainer 460 is enabled, while still providing sufficient sealing force even after material relaxation due to elevated temperature exposure for extended time while stressed. 3) The need for high precision alignment of the seal member 451 is eliminated by use of a flat gasket geometry. 4) Simple snap-on assembly is provided. 5) Spring rates are provided that permit sufficient force generation, while still accommodating the expected dimensional variation of the system.

In the embodiments described above, the user removes the seal 450 from the ink tank 260 by grasping the second portion 463 of the wall 461 and pulling it outward until the latch opening 464 is free of the projection 261 (FIG. 7). As the seal retainer 460 continues to be pivoted around the first hook 491 and the second hook 492, the housing 480 and the seal member 451 move away from the outlet port 272 (FIG. 6) on the ink tank 260. A twisting motion can then be applied to disengage one of the first hook 491 and the second hook 492 and then the other one. Other means of spreading the first hook 491 and the second hook 492 apart so that they can be released from the indentations 290 can alternatively be used.

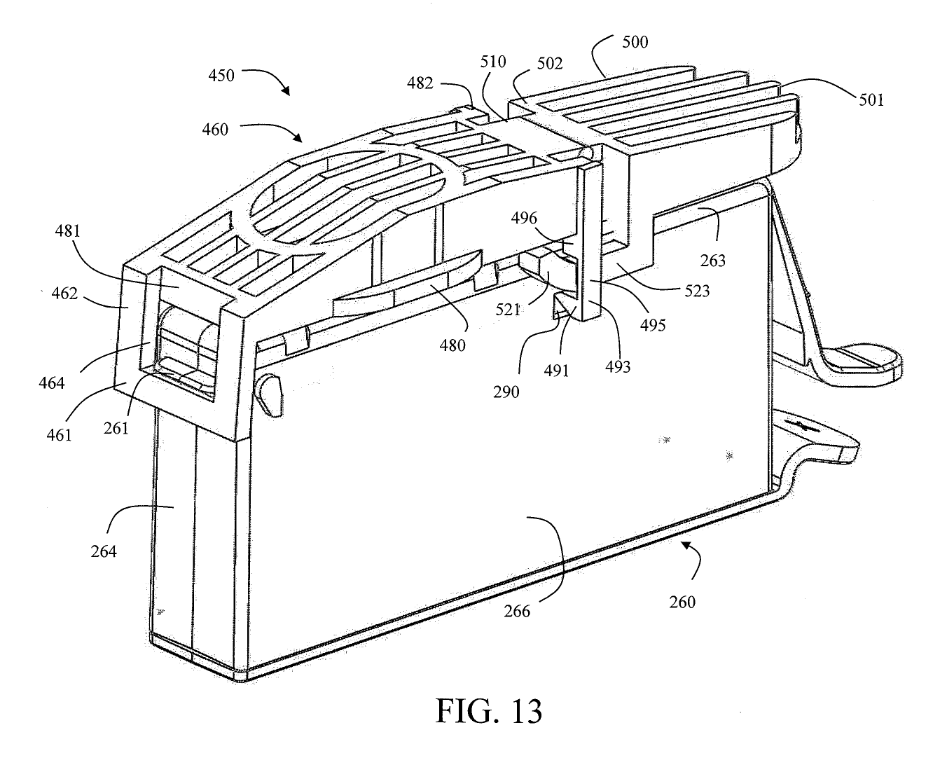

An embodiment of a the seal 450 is next described with reference to FIGS. 13-19, in which a handle 500 is attached by a hinge member 510 to the housing 480 and in which the handle 500 has wedge-shaped members (wedge-shaped feet 521 and 522) that spread the first hook 491 and the second hook 492 as the handle 500 is pivoted away from the outlet wall 263 so that they can be easily removed from the indentations 290 on the first side wall 266 and the second side wall 267 of the ink tank 260.

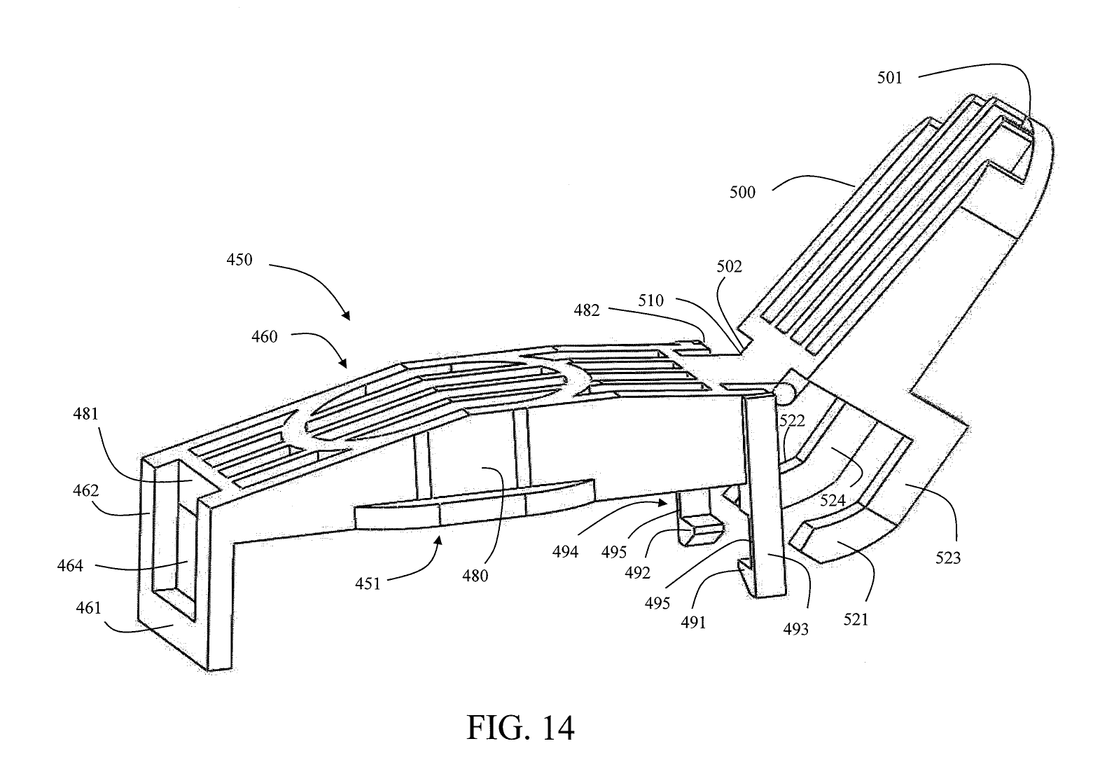

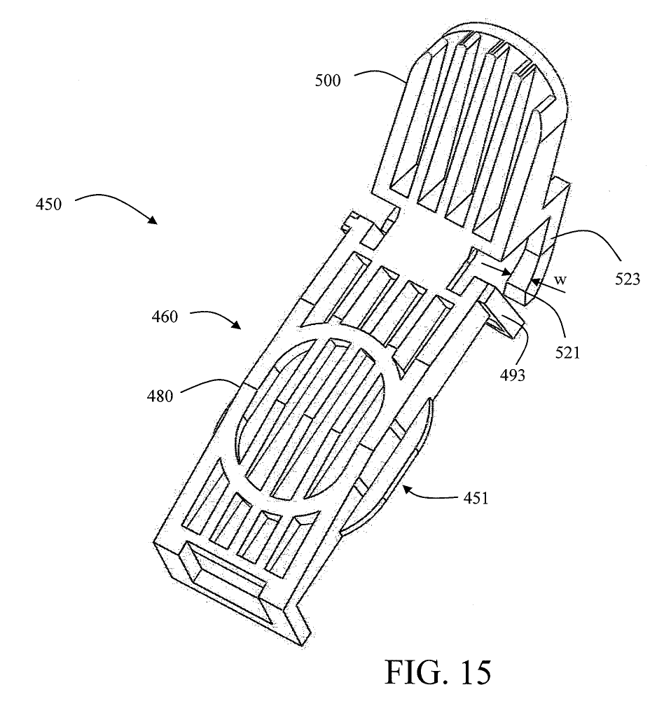

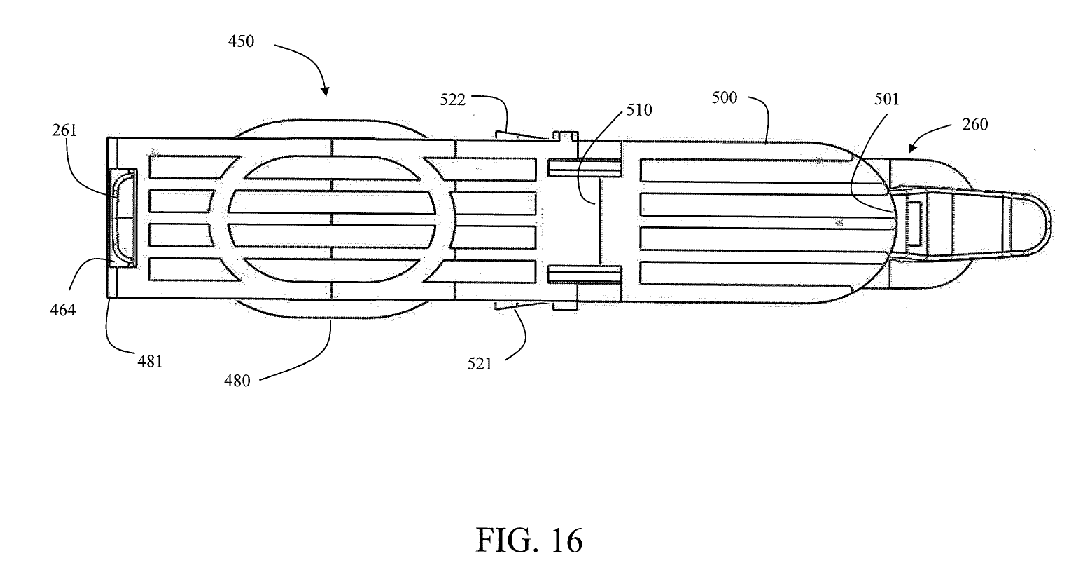

FIG. 13 shows a perspective of the seal 450 attached to the ink tank 260, where the seal 450 includes the handle 500. The configuration of FIG. 13, where the seal 450 is installed on the ink tank 260 with the seal member 451 (FIG. 14) pressed against the outlet port 272 (FIG. 6) is called the sealed state herein. Many of the features of the seal 450 have been described above with reference to FIGS. 7-12, and do not need to be described again except to explain the changes in this embodiment. As in the embodiment shown in FIG. 7, in the embodiment shown in FIG. 13 the wall 461 extends from the first end 481 of the housing 480, i.e. at an end that is opposite the second end 482 that is adjacent the hinge member 510. The latch opening 464 in the first portion 462 of the wall 461 engages with the protrusion 261 on the lead end wall 264 as before. However, the wall 461 does not have a second portion that extends obliquely for the user to grasp during removal of seal 450. Instead, the handle 500 is attached to the second end 482 of the housing 480 by the hinge member 510 at a hinged end 502 of the handle 500. Opposite the hinged end 502, the handle 500 includes a free end 501 that the user pivots away from the outlet wall 263 during removal of the seal 450. The seal retainer 460 includes a first leg 493 having the first hook 491 on the first side of the seal retainer and a second leg 494 (FIG. 14) having the second hook 492 on a second side opposite the first side. The first leg 493 has a thinned portion 495 between the first hook 491 and a projection 496. Likewise, the second leg 494 has the thinned portion 495 and the projection 496, but they are not shown. The handle 500 includes a third leg 523 near the first leg 493, and a fourth leg 524 near the second leg 494 (FIG. 14). In the sealed state, when the seal 450 is installed on the ink tank 260, the third leg 523 and the fourth leg 524 are nested between the first leg 493 and the second leg 494 at the thinned portion 495 between the hook 491 or 492 and the projection 496. This is possible because the fourth leg 524 is separated from the third leg 523 by a distance that is less than a distance that separates the second leg 494 from the first leg 493, as seen in FIGS. 14 and 15. In the sealed state, the first wedge-shaped foot 521 on the third leg 523 is inserted through the thinned portion 495 of the first leg 493 so that it is near the housing 480. Likewise in the sealed state, the second wedge-shaped foot 522 on the fourth leg 524 (FIGS. 14 and 16) is inserted through the thinned portion 495 of the second leg 494 so that it is also near the housing 480.

FIGS. 14 and 15 are top perspectives of the seal 450 in a removed state in which the third leg 523 and the fourth leg 524 are removed from between the first leg 493 and the second leg 494 respectively, and the seal member 451 is removed from the outlet port 272 of the ink tank 260 (FIG. 6). In the removed state, the first wedge-shaped feet 521 and the second wedge-shaped feet 522 are no longer near the housing 480 as they were in the sealed state described above. The perspective of FIG. 15 is such that the variation in width w of the wedge-shaped foot 521 is seen. The wedge shape of the first wedge-shaped feet 521 and the second wedge-shaped feet 522 is even more evident in the top view of FIG. 16, where the seal 450 is installed on the ink tank 260 and is in the sealed state.

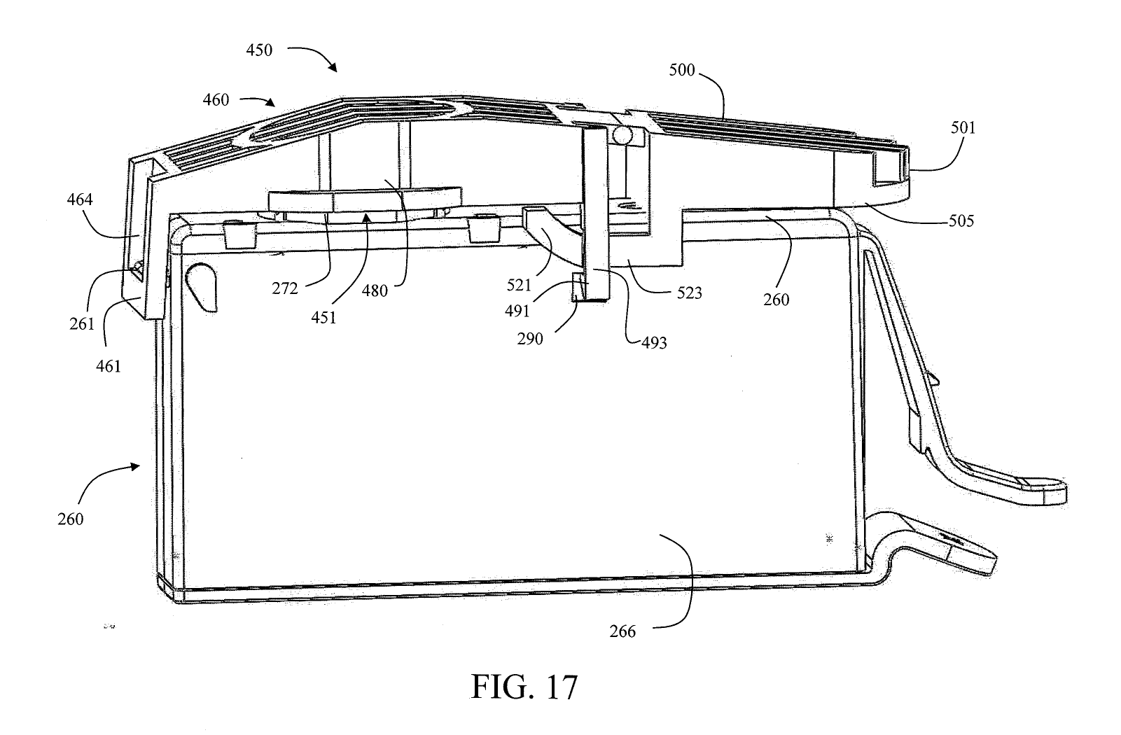

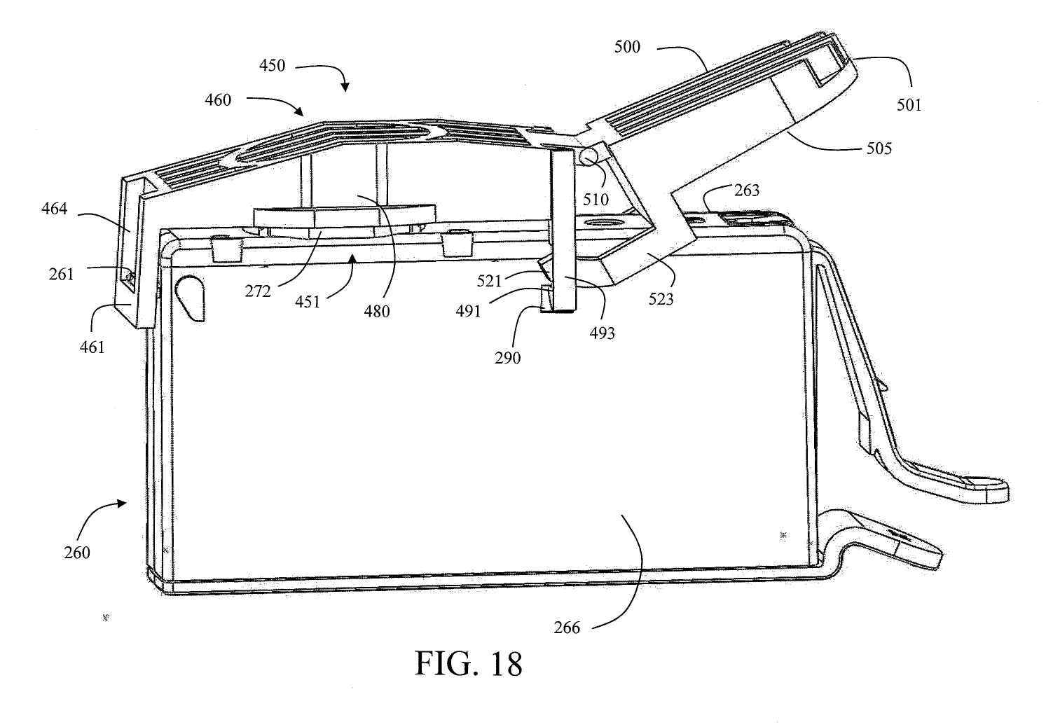

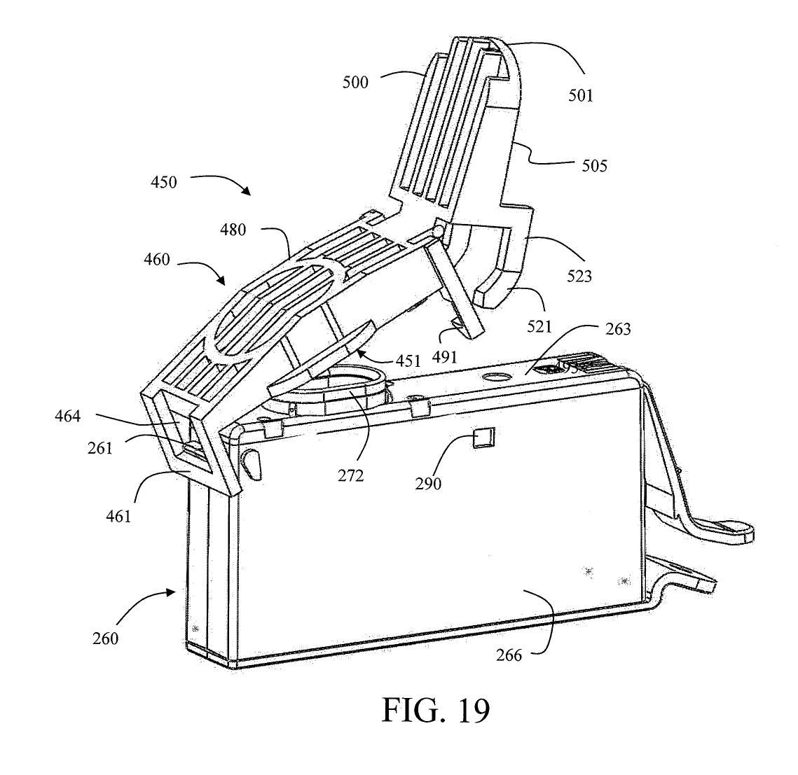

FIGS. 17-19 show a sequence of configurations of the seal 450 and the ink tank 260, beginning at the sealed state of FIG. 17, progressing to an intermediate state of FIG. 18, and finally to the removed stated of FIG. 19. In the sealed state of FIG. 17, the seal 450 is latched to the ink tank 260 by the protrusion 261 being engaged in the latch opening 464 of the wall 461, and by the first hook 491 being disposed in the indentation 290 in the first side wall 266, as well as by the second hook 492 (not shown) being similarly engaged in the indentation 290 in the second side wall 267. The seal member 451 is pressed against the outlet port 272 of the ink tank 260 by the housing 480 of the seal retainer 460. The third leg 523 is nested between the first leg 493 and the first side wall 266 so that the wedge-shaped foot 521 is near the housing 480. Similarly, although not shown, the fourth leg 525 is nested between the second leg 494 and the second side wall 267, so that the second wedge-shaped foot 522 is near the housing 480. A bottom side 505 of the handle 500 is parallel to, or substantially parallel to the outlet wall 263 of the ink tank 260. In other words, the bottom side 505 is at an angle of approximately 0 degrees relative to the outlet wall 263.

In the intermediate state shown in FIG. 18, the free end 501 of the handle 500 has been pivoted away from the outlet wall 263 of the ink tank 260 around the hinge member 510 so that the bottom side 505 of the handle 500 is at an angle of about 30 degrees relative to the outlet wall 263. As a result, the third leg 523 has been pulled partially through the gap between the first side wall 266 and the first leg 493 so that the wedge-shaped foot 521 has pushed the first hook 491 outward and away from the indentation 290 in the first side wall 266. Similarly, although not shown, the second wedge-shaped foot 522 has pushed the second hook 492 outward and away from the indentation 290 in the second side wall 267. The first hook 491 and the second hook 492 are still near the respective indentations 290, but they are almost free to pivot upward with the handle 500. The protrusion 261 is still engaged in the latch opening 464 and the seal member 451 is still pressed against the outlet port 272 of the ink tank 260. In the intermediate state of FIG. 18, the first leg 493 and the second leg 494 (FIG. 14) are separated by a greater distance than they are when in the sealed state of FIG. 17, because the first wedge-shaped feet 521 and the second wedge-shaped feet 522 have spread them apart further. As can be seen by comparing FIG. 18 with FIG. 17 and FIG. 19, the handle 500 is oriented at a first position for the sealed state (FIG. 17), at a second position for the removed state (FIG. 19), and at a third position for the intermediate state (FIG. 18), where the third position is intermediate between the first position and the second position. This can also be seen by comparing the angular position of the bottom surface 505 of the handle 500 relative to the outlet wall 263 in the three states.

In the removed state of FIG. 19, the free end 501 of the handle 500 has been pivoted still further away from the outlet wall 263 of the ink tank 260 so that bottom surface 505 is at an angle of about 70 degrees relative to the outlet wall 263. The first hook 491 is completely disengaged from the indentation 290 on the first side wall 266 (and similarly for the second hook 492), so that the seal retainer 460 now pivots around the protrusion 261 at the latch opening 464. The seal member 451 is removed from the outlet port 272. The third leg 523 and the fourth leg 524 (FIG. 14) are removed from between the first leg 493 and the second leg 494. The seal 450 can now be lifted off of ink tank 260 and discarded so that the ink tank 260 can be installed into the printhead 250 (FIG. 5).

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
240 Standpipe
241 Holding receptacle
242 Inlet port
243 Inner wall
244 Opening
245 End
247 Gasket
249 Partitioning wall
250 Printhead
251 Printhead die
253 Nozzle array
254 Nozzle array direction
256 Encapsulant
257 Flex circuit
258 Connector board
260 Ink tank
261 Protrusion
263 Outlet wall
264 Lead end wall
265 Trail end wall
266 First side wall
267 Second side wall
268 Lid
270 Body
271 End face (of outlet port)
272 Outlet port
273 First end (of outlet port)
274 Second end (of outlet port)
277 Wick
281 Electrical device
282 Latch lever
283 Guide feature
290 Indentation
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
370 Stack of media
371 Top piece of medium
380 Carriage motor
382 Carriage guide rail
383 Encoder fence
384 Belt
390 Printer electronics board
392 Cable connectors
401 Shaped seal member
402 Sealing face
450 Seal
451 Seal member (flat gasket)
452 Sealing face
460 Seal retainer
461 Wall
462 First portion (of wall)
463 Second portion (of wall)
464 Latch opening
465 Edge (of latch opening)
480 Housing
481 First end (of housing)
482 Second end (of housing)
483 First outer side
484 Second outer side
485 Rib(s)
486 Braces
491 First hook
492 Second hook
493 First leg
494 Second leg
495 Thinned portion
496 Projection
500 Handle
501 Free end (of handle)
502 Hinged end (of handle)
505 Bottom side (of handle)
510 Hinge member
521 First wedge-shaped foot
522 Second wedge-shaped foot
523 Third leg
524 Fourth leg
F₁ Compressive Force
F₂ Compressive Force
T₁ First Thickness
T₂ Second Thickness
A-A′ Midplane

1. A seal for an outlet port of an ink tank, the seal comprising:
a seal member; and
a seal retainer comprising:
a housing for the seal member, the housing including a first thickness near a first end and a second thickness near a second end, wherein the first thickness does not equal the second thickness;
a wall extending from the first end of the housing, the wall including a latch opening;
a first hook on a first side of the seal retainer; and
a second hook on a second side of the seal retainer, the second side being opposite the first side, wherein the first hook and second hook are disposed proximate the second end of the housing, and wherein a force applied to the seal member by the housing near the first end is equal to or substantially equal to a force applied to the seal member by the housing near the second end when the seal is assembled onto the ink tank.

2. The seal of claim 1, the seal member including a sealing face, wherein an outer side of the housing is parallel to or substantially parallel to the sealing face near the second end of the housing, and wherein the outer side is sloped relative to the sealing face near the first end of the housing.

3. The seal of claim 1, wherein the second thickness is greater than the first thickness.

4. The seal of claim 1, wherein a first portion of the wall near the seal member extends perpendicular to or substantially perpendicular to the seal member.

5. The seal of claim 4, wherein a second portion of the wall that is distal to the seal member extends obliquely relative to the seal member.

6. The seal of claim 4, wherein the latch opening is disposed in the first portion of the wall.

7. The seal of claim 1, wherein the housing includes a plurality of ribs that extend along a direction from the first end to the second end.

8. The seal of claim 7, wherein the housing further includes a plurality of braces that join adjacent ribs.

9. The seal of claim 8, wherein the plurality of braces form a curved contour.

10. The seal of claim 9, wherein the curved contour is the same as a contour of the outlet port of the ink tank.

11. The seal of claim 1, wherein the seal retainer comprises an unfilled plastic material.

12. The seal of claim 11, wherein the seal retainer comprises polypropylene.

13. The seal of claim 11, wherein the unfilled plastic material has a Young's modulus that is between 100,000 and 500,000 pounds per square inch.

14.-20. (canceled)
